(19) United States
(12) Patent Application Publication
(10) Pub. No.: US 2020/0042630 A1
(43) Pub. Date: Feb. 6, 2020

(54) METHOD AND SYSTEM FOR LARGE-SCALE DATA LOADING

(71) Applicant: Metis Machine, LLC, Charlottesville, VA (US)

(72) Inventors: Saul Zachariah Yeaton, Charlottesville, VA (US); Michael Prichard, Charlottesville, VA (US); Wesley Cope, Clover, SC (US); Jeremy Tregunna, Granadilla de Curridabat (CR); Kevin Musselman, Seneca, SC (US); David Sison, Louisa, VA (US)

(21) Appl. No.: 16/053,461

(22) Filed: Aug. 2, 2018

(51) Int. Cl. G06F 17/30; G06F 15/18

(52) U.S. Cl. CPC G06F 17/30563; G06F 15/18; G06F 17/30584; G06F 17/30427

(57) ABSTRACT

The present invention provides a method and system for large-scale data loading including generating a data science model with at least one million data points. The method and system includes determining at least one native data resource having native data stored thereon and determining a size of the model data generated from the native data by translating a model query format of the data science model into a native query format of the native data resource. The method and system queries the native data resources using the data science model and receiving the model data, including transporting the model data to temporary data resources. The method and system engages the model data with the data science model and trains the data science model using the model data stored in the temporary data resources. Where the iterative training process requires multiple data-loading operations made possible under the present method and system.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### FIELD OF INVENTION

The present invention relates generally to data loading operations relating to large-scale data processing operations and more specifically to extract, transform and load operations associated with large-scale data sets and modeling.

### BACKGROUND

Data sampling and data modeling techniques are well known. When dealing with large data sets, for example data having 100 MM+data points, traditional data operations fail because the scale of the data is beyond traditional technology. In larger data sets, complications arise because of the amount of data, distribution of the large data sets, and lack of uniformity in the data. When users seeks to leverage data science operations across these large data sets, it becomes an almost unmanageable situation because merging these disparate large data sets is untenable with existing methods and infrastructure. The inability to load large data sets causes complications with data science modeling and training.

Integrating these large data sets becomes a slow and laborious operation. There are several known techniques for training data science models applied to large-scale data sets, all having inherent problems, including speed and reliability. For example, one technique is to sample a fraction of the data set, such as sampling millions of rows of data into memory to train a data science model. Another technique is to score millions of rows of data using a developed model. Using this small sample set of millions of rows of data, one technique is to evaluate the accuracy of a model on these millions of rows.

Traditional businesses seek to leverage historical and third-party data sets to optimize business operations and decisions. For example, modeling techniques can seek to analyze decades of data from internal transactions, e.g. customer purchases, and external data, e.g. industry trends, financial markets, weather patterns, etc.

These current model techniques typically involve manual cycles of data processing including steps of estimating the infrastructure requirement needed for processing operations, manually allocating infrastructure determined by the requirement needs and loading data to this infrastructure. For example, the infrastructure requirement may include needing access to large data storage facilities in a networked environment, as well as access to a large number of networked processing devices. In this manual cycle, the step of loading the data to the infrastructure is estimated, so these steps may need to be repeated until the data is fully loaded, for example experiencing a failed data load, having to increase the estimated infrastructure requirements, updating the allocation of infrastructure, and then attempting to load data again.

If the load is done properly, these prior techniques then include executing data science model training using the loaded data, and then executing data science model scoring. The manual cycle then requires an operator to manually review the models and possible re-execute the models as necessary. An output is scored to a readable format, this then allows for retraining the models as needed and finally ingest updated data.

When dealing with large data sets, it becomes cost and time prohibitive to train and score multiple iterations of the model. When needing to load these large data sets for model execution, you incur load time and costs for each model iteration. For large-scale data sets, the load time can be hours or even days, depending on available resources and transmission bandwidth. Then, running an iteration of the model scoring multiplies this overhead. For example, if you wanted to train and score a model using 1000 iterations, even a five hour data load operation would then translate to at least 5000 hours of data loading.

Thus, current techniques for large-scale data loading become either time prohibitive or the model cannot be properly trained because of limited numbers of iterations. These current techniques are resource intensive, timely, and costly. Each attempt to load data and execute models includes significant overhead of costs, time, and processing power. Therefore, there exists a need for a method and system providing for large-scale data loading, which then allows for data training and scoring techniques.

### BRIEF DESCRIPTION

The present invention provides large-scale data loading, where the scale of the data is at least one million data points, but typically operates in the multiple millions or even billions of data points. In typical large-scale data loading operations, the data points can exceed hundreds of millions or in the billions.

The method and system includes generating a data science model. The data science model can be for any suitable processing operation or operations, including for example for predictive analytics, finding patterns, finding similarities, etc. The generating of the data science model includes building the model including using data processing and query operations. The data science model can be an iterative model subject to refinement based on scoring the model. The data science model operates to perform data mining and operational analysis of the large-scale data.

The method and system includes determining at least one native data resource having native data stored therein. The native data resource can be any number of localized or networked resources storing unified, or disparate data. The method and system therein determines a size of the model data generated from the native data by translating a model query format of the data science model into a native query format of the native data resource.

Based on the anticipated model data to be received in response to the query, the method and system includes determining a size of the model data generated from the native data. From this model data size, the method and system can then manage temporary data resources and data transmission operations associated with the large-scale data load. The temporary data resources can be any number of servers or other resources made available for a determined time period, such as for example 1000 servers being available for a one-hour period. The size of temporary resources is determined based on the size of the native data load, performance requirements, as well as the model itself. For example, by default, the system can assume a target response rate such as 5 minutes. Using a combination of system metrics and initial responses, additional resources (servers, memory and faster processors) can be added in order to accelerate the completion of the overall job within the target timeframe. This default time period is adjustable based on performance and cost considerations. The duration of the resources can be made available based on the model, learning operations, and other factors.

The allocation of resources can occur in a number of different techniques. For example, cloud-based resources may be dynamically created, e.g. a new server is instantiated, configured, and allocated within seconds. Another example is load balancing by re-allocation of existing unused or under-used resources including local and/or cloud-based resources. Similarly, allocation can use a combination of different techniques.

The method and system includes querying the native data resources using the invention for receiving the model data in response thereto. Based on the volume of data, the method and system includes partitioning the model data and transporting the model data to the temporary data resources using parallel transmissions based on the partitioning. Therein, the method and system provides for reconstituting the model data from the parallel transmissions, the model data being stored in the temporary data resources.

The method and system provides for improved data loading techniques allowing the uploading of the model data for use by one or more data processing systems to train the data science model data stored in memory. The training of the model includes the development of the model, including selecting of various factors or conditions in the model.

From the training of the model, the method and system provides for execution of the model on the model data. This scoring of the model results in generating a result with multiple qualifiers. Due to the nature of the data science model, the value of scoring the model is the iterative process to modify model factors as part of the training.

Therefore, the method and system further provides for additional training of the model by adjusting the model factors. This adjustment of the model for accuracy and or performance optimization requires additional or repeated data loading operations, whereby the present method and system further optimizes the model training and scoring techniques by reducing data load times.

In further embodiments, the native data may be disposed in a plurality of data resources in different locations. The method and system provides efficient routing of these non-co-resident data sources. A first step is to open communication channels between the native data source and the temporary data resource and then apply a two-way transformation function. As the data passes from one side to the other, the transformation function converts data into a different format, compatible with the other channel. Similarly, the conversion reverses the process when sending data back across the channel.

Utilizing further methods and systems described herein, the present invention provides for large-scale data loading for association with data science model training and scoring techniques. The large-scale data loading operations allow for time and cost efficiency model training and scoring.

### BRIEF DESCRIPTION OF THE DRAWINGS

FIG. 1 illustrates a system diagram for a computer processing system providing for large-scale data loading;

FIG. 2 illustrates a flowchart of the steps of one embodiment of a method for large-scale data loading;

FIG. 3 illustrates a functional block diagram representing one embodiment for large-scale loading;

FIG. 4 illustrates a flowchart of the steps for data science model training using large-scale data loading;

FIG. 5 illustrates a system diagram for a data modeling operations with large-scale data loading with distributed native data storage; and

FIG. 6 illustrates a sample screenshot of a data science model training operation.

A better understanding of the disclosed technology will be obtained from the following detailed description of the preferred embodiments taken in conjunction with the drawings and the attached claims.

### DETAILED DESCRIPTION

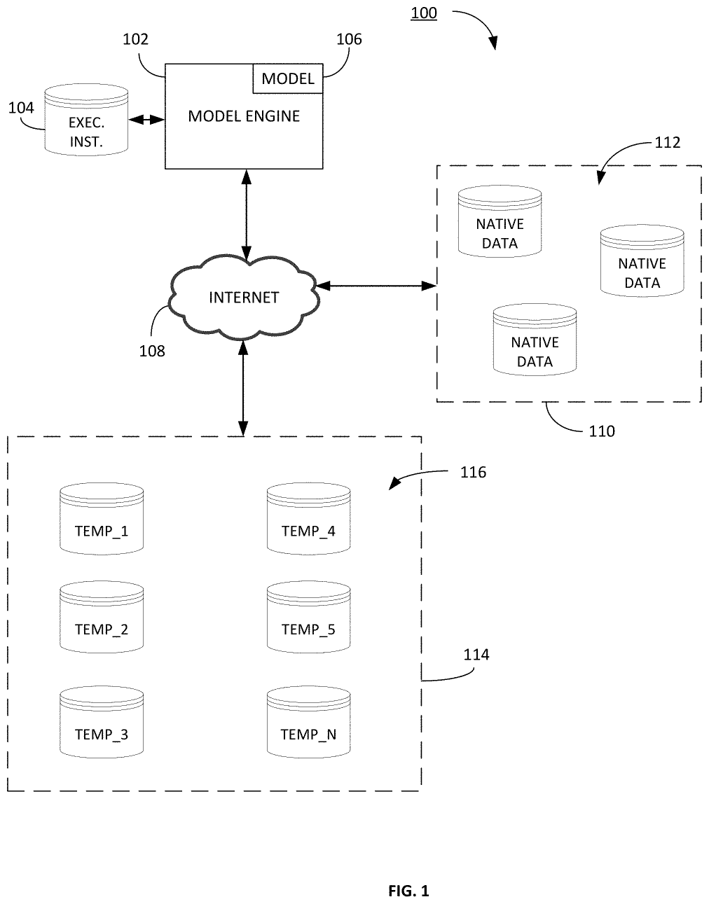

FIG. 1 illustrates a block diagram of a system 100 for large-scale data loading. As noted herein, large-scale data loading applied to large-scale data sets, which are data sets having at least one million data points and more typically in the multiple of millions or billions of data points. The sheer volume of data makes prior modeling techniques functionally limited due to time, size, and other operations factors.

The system 100 includes a processing device 102 operative to execute the large-scale data loading in response to executable instructions 104. The processing engine 102 further includes a data science model 106.

The processing device 102 communicates via a network 108 to a native data resource 110, accessing native data 112 stored thereon. The processing device 102 further communicates with temporary storage 114 having model data 116 stored thereon.

As described in further detail below, the system 100 provides for large-scale data loading associated with the data science model. The processing engine 102 may be one or more processing devices operative to perform a variety of processing operations, including operations as described herein. The model 106 may be one or more computer science data models applicable to large-scale data, including for example data mining, trend analysis, etc., as recognized by one skilled in the art. A data science model may be a predictive model seeking to use a very large data set and predict a result therefrom. By way of example, one model may be a model to predict the weather using a large amount of data from a variety of sources.

The engine 102 may be a centrally located processing device or can be a distributed processing environment running across any number of networks or computing nodes. As described herein, the method and system provides for a high volume of data processing across a distributed environment, the engine 102 helps facilitate the data load, as well as model training operations.

The network 108 is typically the Internet or any other suitable network. For example, the network 108 could be an internal secured network. The network 108 may additionally include security protocols, encryption, or other security techniques as recognized by one skilled in the art.

The native data resources 110 can be one or more data resources in a centralized or in a distributed environment Native data can be a unitary data set in a unified format, such as for example consumer credit card information, public voting information, web traffic information, etc. Native data can also be multiple data sets in unified or divergent formats, including from common resources or from disparate resources.

In the above model example of predicting weather, the native data can be a large variety of information, including for example historical weather data, regional weather data, ocean current data, wind data, geographical or topography data, tidal data, hurricane data, other forecasting model data, etc. This native data can be in different formats for each stored database and each database can be in a wide variety of locations. For example, hurricane data could come from National Oceanic and Atmospheric Administration and regional weather data could come from National Weather Service.

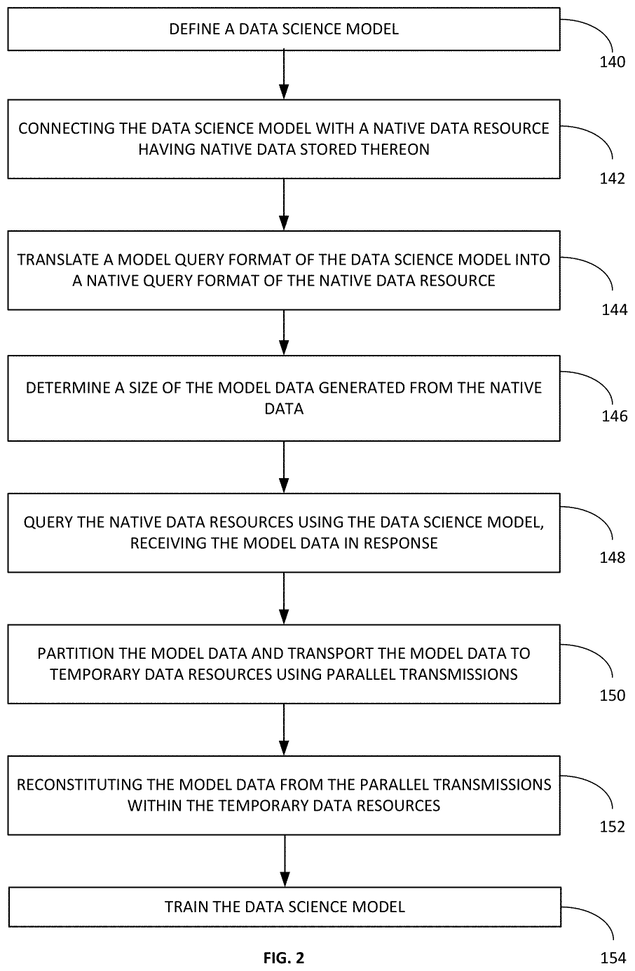

As described in greater detail below, the model 106 accesses the native data 112 in response to a query, generating model data 116. The model data 116 is stored in the temporary data resource 114, which can be any suitable resource including enough storage devices and associated processing power for the modeling operations. The temporary resource 114 is termed temporary because it is used for the model training and scoring operations, the data is discarded post modeling operations and the resources 114 are then available for further operations. For example, the temporary resources may be cloud-based computing resources available for rent or usage on a short-term basis, as may be allocated by the engine 102.

Where FIG. 1 illustrates one embodiment of a processing system 100, FIG. 2 illustrates a flowchart of the steps of one embodiment of a method for large-scale data loading. The methodology of FIG. 2 may be performed using the system 100 of FIG. 1, including executable operations 104 performed by the processing device 102.

A first step, step 140, is generate a data science model. This data science model may be a pre-existing model looking for data analysis or may be a newly designed model using selected design parameters to determine if specific information is found within large-scale data sets. As understood, the data science model can be any suitable model available for large-scale data analysis, including modelling relating to predictive analytics, trend-based analytics, pattern detection, by way of example.

Using the above example of a weather-predictive data science model, the data load for this model training and scoring can be outside of the available resources of prior techniques. For example, to predict a weather forecast occurring in 24 hours within a 2-degree range of accuracy and a 10% chance of precipitation accuracy for all zip codes within the United States can require multiple millions, if not billions, of data points. Additionally, the inclusion of a time factor, here the example of 24 hours, creates an inherent limitation requiring high efficiency of data loading for modeling operations.

As part of loading data, step 140 includes authorizing the model to access one or more resources. For example, if the resource is a proprietary database, the model must be given permissions. For example, if the resource includes security restrictions or privacy controls, the model includes corresponding security or privacy controls. In the example of weather data, this can include access rights to federal data, access to historical modeling data, access to proprietary data, etc.

Step 142 is connecting the data science model with a native data resource having the native data stored thereon. Referring back to FIG. 1, the native data 112 may be stored in a native resource 110.

Similarly, the native data 112 may not be directly accessible, thus one or more server access operations may be required to translate or otherwise make the native data 112 available to the model 106 of FIG. 1. Therefore, where required, step 144 of FIG. 2 is to translate a model query format of the data science model into a native query format of the native data resource.

Step 146 is to determine a size of the model data generated from the native data based on the model inquiry. The model training typically involves an SQL data call operation, returning randomly-sampled model data in response. This model therein extracts selected data points from the native data 112. The method and system includes determining the anticipated volume of return data from the model calls. The native data is in a native format, not necessarily readily usable by the model. Therefore, a degree of translation can be required to make the native data usable by the model. For example, if the native data has a billion data points and the model data only needs 10% of those data points, the data load is reduced by the eliminating the need to load, process, or otherwise interact with 90% of the native data.

This size determination of step 146 may include informing the model of how to expect the model data in return to the query, as well as analyze the size of the data set.

In one embodiment, the data transfer is improved by allocation of local or temporary resources. In one embodiment, the method determines the anticipated size of the forthcoming data load and allocates memory resources for receipt of the model data. As noted above, allocation of resources can be dynamic creation of cloud-based servers, load-balancing of existing of existing servers, or combinations thereof. Therefore, the method insures local resources are ready and available for the large-scale data loading operation.

Step 148 is to query the native data resources using the data science model, receiving the model data in response. In the example of a data science model for predicting weather, the native data query can be different for each native resource. For example, a database of historical weather information can select retrieval of data on a per-zip-code basis and returning the historical data for neighboring zip codes over a period of two weeks.

In one embodiment, the transfer of model data from different sources can occur at different speeds. For example, if one native server is readily accessible and providing a smaller amount of data, this transfer can occur at a much quicker than another native server that requires one or two levels of data access operations across an internal network. Therefore, one embodiment can include accounting for data transfer rates associated with different native resources when managing the large-scale data loading.

Step 150 is to partition the model data and transport the model data to temporary data resources using parallel transmissions. For example, step 150 may include routing efficiency operations for detecting optimized pathways and data transmission loads for transferring the model data from the native resources 110 to temporary resources 114 of FIG. 1.

Thereby, step 152 is to reconstitute the model data from the transmissions within the temporary data resources. The transmission of model data can be in serial or parallel transmissions, using known data transmission techniques. In other embodiments, the routing of data is optimized using data transmission techniques, including parallelization. The routing is optimized for response speed or partition tolerance across heterogenous nodes.

Therefore, the model data is now available for modeling operations in a timely and efficient manner. Where step 140 above was generating the data science model, step 154 provides for training the data science model using the model data. As described in further detail below, the improved large-scale data loading thereby enables timely and efficient model training. The training of the data science model includes multiple data processing and query operations.

As described in greater detail below, the training of the model includes multiple iterations of model execution, modifying various model parameters between executions. Each of these executions then entails additional large-scale data loading.

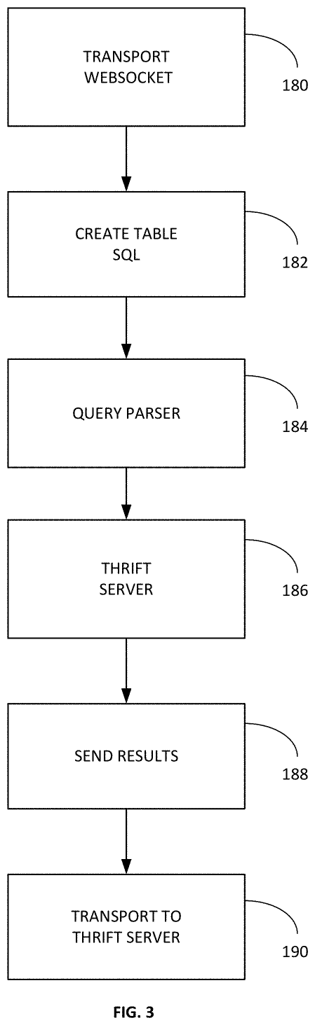

The methodology of FIG. 2 provides for loading a large-scale data set available for data modeling operations. The method and system determines the estimated large-scale data set to be received from the native data based on the expected query response from the model. Using this estimated data set size, the method and system utilizes temporary resources for the model data receipt and modeling operations. Transfer of the model data is further enhanced using partitioning operations and later reconstituting the data as appropriate.

Where FIG. 2 illustrates the methodology of large-scale data loading, FIG. 3 illustrates data processing steps for large-scale data loading. These operational steps may be performed by user-defined functionality, as well as generalized data processing operations.

Step 180 is to transport SQL via a web socket. By way of example, the web socket can be Apache Spark SQL, CQL, or any other suitable technique recognized by one skilled in the art. Step 182 is to create a table relating to the large-scale data set. The table is part of the allocation of resources. Steps 180, 182 are functions associated with development kit functionalities for operating within the processing system.

Step 184 is to query the parser. This query step includes validating the query logic, such as standard query logic or contextual query logic. This query step includes creating a table alias, such as project_token.table, fetching all tables in one or more data stores. In one embodiment, an algorithm can insure naming collisions amongst tables. Moreover, the query step can include creating a view into the data using the table alias.

Step 186 is to utilizes an Apache Thrift server or any other suitable server enabling data transfer operations. For example, one embodiment leverages Apache Thrift protocol allowing for defining and creating services between different programming languages. Utilizing the thrift server creates network channels between multiple hosts, enabling improved data transfer operations.

Step 188, in response to the query parser operations, is to send results from the native data storage. This step may include packaging results and/or error messages, as well as delivering results.

Steps 184, 186, and 188 are processing operations, therefore they can be performed on any suitable processing environment.

Step 190 is to transport to the thrift server. This step includes a developer kit creating a web socket to a data engine and storing connections in memory. The functionality uses open connects to send result type and data to the development kit, as well as reversing an alias created in step 184.

In accordance with known techniques, the Thrift server inherently manages cross-language microservices usable for the large-scale data loading. Moreover, the persistent web socket enables large-scale data sharing between client and server using known data transmission techniques.

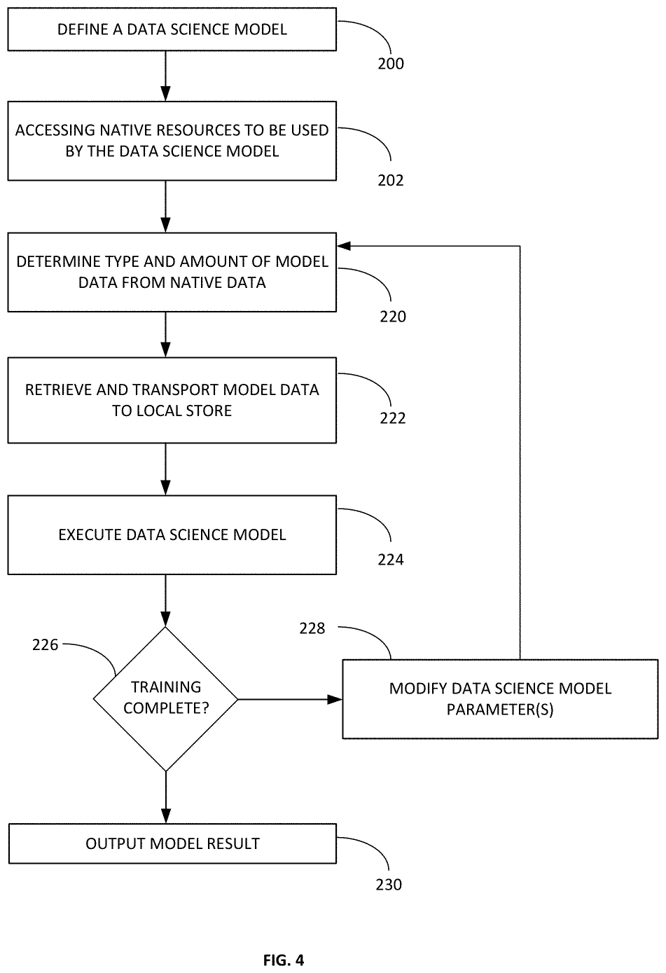

The above methodology, executable within one or more computer processing systems, improves data science model training by making the large-scale data available in an improved manner. FIG. 4 illustrates a method of steps for data science model training using the large-scale data loading.

Step 200 is to define a data science model. As noted above, the data science model can seek modeling operations for any number of goals, accomplished through large-scale data analysis acquired from external sources. The data science model may be defined using known data science modeling techniques, where the model herein accesses larger data sets in a quicker manner, improving the model accuracy.

Step 202 is to access native resources storing native data to be used by the model. The native resources may be centrally stored, such as in a centralized location. In alternative embodiments, the native resources may be distributed across multiple locations.

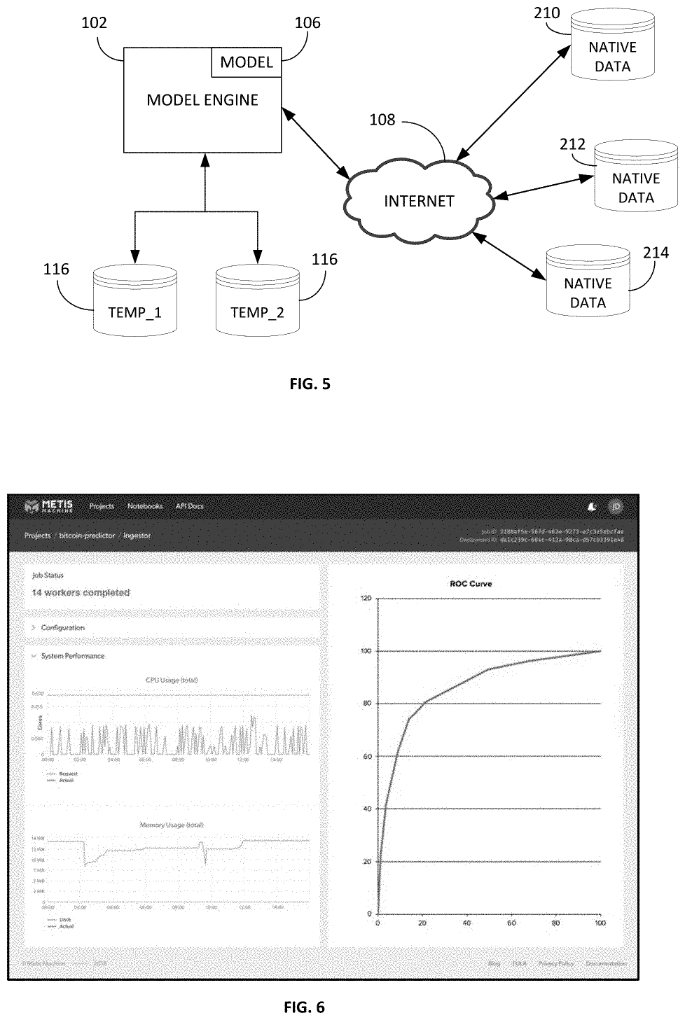

By way of example, FIG. 5 illustrates a model training system, similar to FIG. 1, where the native data is stored in disparate locations 210, 212, and 214. Using the weather example above, the server 210 may be a government-controlled data resource, the server 212 may be a private meteorological or other data service, and server 214 may be a public server of historical temperature information.

In the system of FIG. 5, the model 106 is trained within the model engine 102 using temporary servers 116 to store the model data received via the network 108.

The disparate locations of the native servers can complicate large-scale data loading based on multiple factors, including the amount and type of data being accessed, the accessibility of the server and the data, native data server loads, security, encryption concerns, etc.

Here, the routing operations provide for opening communication channels from the different sources (e.g. servers 210-214) to the destination (e.g. memory 116). The routing can then apply a two-way transformation function, such as using the Apache Thrift server as described above. As the data passes from one side to the other, the transformation function converts data into a different format compatible with the other channel, as well as vice-versa.

With reference back to FIG. 4, step 220 is to determine type and amount of model data from native data. As described above, this includes using the model query as the guide. Step 222 is to retrieve and transport model data to the local store. The retrieval and transport, such as described in greater detail relative to FIGS. 2-3 above, provides the large-scale data loading that makes data modeling available.

Therefore, step 224 is to execute the data science model running the model against the locally-stored data. The model is executed in accordance with known model execution techniques.

Step 226 is a determination step, if the training is complete. If not, step 228 is to modify the model. One technique can include modifying the training model using machine learning for model parameter adjustments. The model training may further utilize a scoring system associated with a confidence of the model outcome.

With a modification of one or more model parameters, the method reverts to at least step 220 for further native data access and further large-scale data loading operations. The method further iterates for as many testing cycles requested by a user or determined by modeling optimization routines.

FIG. 6 illustrates a sample screenshot of a model testing iteration. The graphical user interface provides a processing load graph, a memory usage graph, as well as a receiver operating characteristic curve (ROC curve) illustrating model effectiveness. The ROC curve illustrates the scoring of the model with multiple training iterations.

With reference back to the flowchart of FIG. 4, once the training of the model is complete, for example having reached a high enough confidence level, the inquiry step 226 is in the negative. For example, the model training may set a confidence level percentage or range based on the iterative scoring the model. Therefore, using repetitive model executions to train the model, the model can eventually achieve a confidence score at an acceptable level. Therefore, step 230 is to output the model results.

When dealing with multiples of millions (and higher) of data points, the prior techniques cannot timely and efficiently manage data transfer operations for iterative model training effectiveness. The present method and system solves data modeling problems associated with large-scale data sets, allowing data model training in timely and cost-effective manners.

FIGS. 1 through 6 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for large-scale data loading, the method comprising:
generating a data science model using model data having at least one million data points;
determining at least one native data resource having native data stored thereon;
determining a size of the model data generated from the native data by translating a model query format of the data science model into a native query format of the native data resource;
querying the native data resources using the data science model and receiving the model data in response thereto;
partitioning the model data and transporting the model data to temporary data resources using parallel transmissions based on the partitioning;
reconstituting the model data from the parallel transmissions within the temporary data resources;
engaging the model data, stored in the temporary data resources, with the data science model; and
training the data science model using the model data stored in the temporary data resources.

2. The method of claim 1 further comprising:
generating a first score for the data science model.

3. The method of claim 2 further comprising:
modifying the data science model to generate a modified data science model;
accessing the at least one native data resource;
querying the native data resource using the modified data science model and receiving modified model data in response thereto;
partitioning the modified model data and transporting the modified model data to the temporary data resources using parallel transmissions based on the partitioning;
reconstituting the modified model data from the parallel transmissions within the temporary data resources;
engaging the modified model data, stored in the temporary data resources, with the data science model; and
training the modified data science model using the model data stored in the temporary data resources.

4. The method of claim 3 further comprising:
generating a second score for the modified data science model; and
comparing the first score with the second score.

5. The method of claim 4 further comprising:
generating an output display comparing the first score with the second score.

6. The method of claim 1, wherein the native data resources are disposed at a plurality of network locations, the method further comprising:
using a thrift server for transporting the model data from the plurality of network locations.

7. The method of claim 1 further comprising:
based on the determining of the size of the model data generated from the native data, determining and allocating temporary resources for receiving the model data from the native data resources.

8. A method for large-scale data loading, the method comprising:
(a) generating a data science model using model data having at least one million data points;
(b) determining at least one native data resource having native data stored thereon;
(c) determining a size of the model data generated from the native data by translating a model query format of the data science model into a native query format of the native data resource;
(d) querying the native data resources using the data science model and receiving the model data in response thereto;
(e) partitioning the model data and transporting the model data to temporary data resources using parallel transmissions based on the partitioning;
(f) reconstituting the model data from the parallel transmissions within the temporary data resources;
(g) engaging the model data, stored in the temporary data resources, with the data science model;
(h) generating a score for the data science model based on step (g);
(i) modifying the data science model; and
(j) training the data model by repeating steps (c)-(i) for at least a pre-determined number of iterations, the pre-determined number of iterations being at least 10 iterations.

9. The method of claim 8 further comprising:
generating a confidence level from the score generated from step (h).

10. The method of claim 9 further comprising:
(j1) training the data model by repeating steps (c)-(i) for: the pre-determined number of iterations and until the confidence level is above a pre-determined threshold.

11. The method of claim 9 further comprising:
generating an output display of the confidence levels generated based on the score from step (h).

12. The method of claim 8, step (i) further comprising:
modifying the data science model using machine learning.

13. The method of claim 8, step (j), wherein the pre-determined number of iterations is at least 100 iterations.

14. A system for large-scale data loading, the apparatus comprising:
a temporary data resource operative to store model data;
a native data resource having native data stored thereon;
a processing device, in response to executable instruction operative to execute a data science model engine, the processing device operative to:
(a) generate a data science model using model data having at least one million data points:
(b) determine a size of the model data generated from the native data by translating a model query format of the data science model into a native query format of the native data resource;
(c) query the native data resources using the data science model and receiving the model data in response thereto;
(d) partitioning the model data and transporting the model data to temporary data resources using parallel transmissions based on the partitioning;
(e) reconstitute the model data from the parallel transmissions within the temporary data resources;
(f) engaging the model data, stored in the temporary data resources, with the data science model;
(g) generating a score for the data science model based on step (f);
(h) modifying the data science model; and
(i) training the data model by repeating steps (b)-(h) for at least a pre-determined number of iterations, the pre-determined number of iterations being at least 10 iterations.

15. The system of claim 14, wherein the processing device is further operative to:
generate a confidence level from the score generated from step (g).

16. The system of claim 14, wherein the processing device is further operative to
(i1) train the data model by repeating steps (b)-(h) for: the pre-determined number of iterations and until the confidence level is above a pre-determined threshold.

17. The system of claim 15, wherein the processing device is further operative to generate an output display of the confidence levels generated based on the score from step (g).

18. The system of claim 14, wherein the processing device is further operative to modify the data science model using machine learning.

19. The system of claim 14, wherein the pre-determined number of iterations is at least 100 iterations.
